(19) United States
(12) Patent Application Publication
(10) Pub. No.: US 2004/0177914 A1
(43) Pub. Date: Sep. 16, 2004

(54) Radially expansible tire assembly drum and method for forming tires

(76) Inventors: Jean-Claude Girard, Copley, OH (US); Andres Ignacio Delgado, Medina, OH (US)

Correspondence Address: The Goodyear Tire & Rubber Company, Patent & Trademark Department - D/823, 144 East Market Street, Akron, OH, 44316-0001, US

(21) Appl. No.: 10/388,773

(22) Filed: Mar. 14, 2003

(51) Int. Cl. B29D 30/24; B29D 30/30

(52) U.S. Cl. 156/133; 156/117; 156/415

(57) ABSTRACT

A method of building a tire carcass onto a toroidially expanded building drum core is disclosed which comprises the steps of applying the carcass components onto a cover of the toroidially expanded building drum core at a first diameter D₁ while rigidly supporting the sides of the cover with a pair of internal side support mechanisms to form a toroidially shaped uncured carcass. The method of building a tire carcass onto a toroidially expanded building drum core further may employ the steps of: expanding the cover radially by an amount less than 5% greater than the diameter D₁ and applying a belt reinforcing structure or a tread and belt reinforcing structure onto the expanded cover to form an uncured tire assembly and may further include the step of curing the uncured tire assembly in a tire curing mold and removing the cured tire assembly from the mold; collapsing the toroidially expanded building drum core; and removing the tire from the collapsed core.

### FIELD OF THE INVENTION

This invention relates to an improved radially expansible tire assembly drum and a method for forming tires from an assemblage of tire components utilizing the assembly drum.

### BACKGROUND OF THE INVENTION

Historically, the pneumatic tire has been fabricated as laminated structure of generally toroidal shape having beads, a tread, a belt reinforcement and carcass. The tire is made of rubber, fabric, and steel. The manufacturing technologies employed for the most part involve assembling the many tire components from flat strips or sheets of material. Each component is placed on a building drum and cut to length such that the ends of a component meet, or overlap, creating a splice.

In the first stage of assembly, the carcass would include one or more plies, and a pair of sidewalls, a pair of apexes, an inner liner (for a tubeless tire), a pair of chafers and perhaps a pair of gum shoulder strips. Annular bead cores can be added during the first stage of tire building, and the ply or plies can be turned around the bead cores to form the “ply turnups.”

Typically, the carcass components (excluding the bead cores) would be either “butt spliced” or “lap spliced.” A butt splice has the component ends joined, but not overlapped. A lap splice has overlapping ends.

This intermediate article of manufacture can be cylindrically formed at this point in the first stage of assembly. The cylindrical carcass is expanded into a toroidal shape after completion of the first-stage of tire building. Reinforcing belts and the tread are added to the intermediate article during a second stage of tire manufacture, which can occur using the same building drum or work station or at a separate shaping station.

During the expansion of the carcass, tensile stresses are imposed on the spliced and uncured components of the tire carcass.

In the case of automobile or light truck tires, lap splices were preferred because the splice remained intact, whereas butt splices would tend to open or fail. Even with the good adhesion of the lap splice, the cords adjacent the splice tended to be stretched compensating for the overlapped two layers of cords at the splice. This localized stretching creates a non-uniformity that is readily visible under x-ray, ultrasonic display or by physically cutting the tire and visually inspecting it.

The tire designer, in order to prevent the creation of tire uniformity problems, has historically insured that the splices of various layers of components were not circumferentially aligned. This non-alignment of splice joints was believed to improve the carcass overall durability and uniformity, as measured by the amount of force variation and the balance of the tire. Tire engineers also have believed that tire uniformity could be improved if these discontinuities were deliberately circumferentially spaced around the carcass. This meant that each component had to be applied to the ply at the tire building station where each component was cut and spliced in a spaced order.

When the cord reinforced plies are placed on the building drum, it is very important that the geometric spacing of the beads and the ply turnups are controlled uniformly. Variations in the overall tire building process can result in variations in cord tension. These non-uniformities can affect the ride and handling characteristics of the tire.

In U.S. Pat. No. 6,250,356 to Michelin, a tire assembly drum is disclosed wherein the beads are two distinct sizes. Conventionally, tires are symmetrical having equal bead diameters. The two distinct diameters on a tire exacerbate the problems of tire building and the disclosed assembly drum provides a method and apparatus to permit the tire to be built in a more uniform and faster way. This building drum was designed to build tires having a given set of two different diameters at the first stage of assembly. A separate tire-shaping drum was used to toroidially shape the tire carcass to assemble the tread and belt reinforcements and that drum is disclosed in U.S. Pat. No. 6,234,227.

The present invention has the objective of providing a building drum that is radially expansible and capable of building tires toroidially while the sides are rigidly supported. In one embodiment, the building drum further has the objective of having axially movable ends, which can permit the assembled carcass to be built and shaped toroidially, avoiding removal of the carcass from the assembly drum for a second stage of tire building wherein the tread and reinforcing belt structure can be applied at the building drum.

### SUMMARY OF THE INVENTION

A method of building a tire carcass onto a toroidially expanded building drum core is disclosed which comprises the steps of applying the carcass components onto a cover of the toroidially expanded building drum core at a first diameter D₁ while rigidly supporting the sides of the cover with a pair of internal side support mechanisms to form a toroidially shaped uncured carcass.

The method of building a tire carcass onto a toroidially expanded building drum core further may employ the steps of: expanding the cover radially by an amount less than 5% greater than the diameter D₁ and applying a belt reinforcing structure or a tread and belt reinforcing structure onto the expanded cover to form an uncured tire assembly and may further include the step of curing the uncured tire assembly in a tire curing mold and removing the cured tire assembly from the mold; collapsing the toroidially expanded building drum core; and removing the tire from the collapsed core.

Alternatively, the method may involve the steps of collapsing the radially expanded building drum core; and removing the formed uncured carcass from the collapsed building core without utilizing the building drum core in the tire curing mold.

Another alternative method of employing the present invention includes building the carcass while the cover is on the toroidially expanded building drum core at the diameter D₁, inserting an annular tread belt in a tire curing mold along with the assembled carcass on the building drum core to form a tire and then inflating the cover to a diameter D₁ plus less than 5% and curing the tire.

The method of building a tire carcass onto a toroidially expanded building drum core has the step of collapsing the radially expanded core including the steps of axially increasing the spacing between the rigidly supported sides and radially lowering the internal side support mechanisms.

The step of lowering the internal side support mechanisms includes the steps of pivotally moving hinged elements of the internal side support mechanisms radially and axially inwardly.

The above method is best performed by a tire building drum rotatable about an axis of rotation.

The tire building drum has a pair of annular axially movable end supports; a pair of collapsible annular sidewall supports, an expandable reinforced annular cover, a means for rotating the tire building drum and a means for axially moving the annular axially movable end supports.

The pair of collapsible annular sidewall supports has a support attached pivotably to each axially movable end support. Each collapsible annular sidewall support has a plurality of pivotably movable hinged elements. The plurality of hinged elements when extended radially forms a collapsible annular sidewall support.

The expandable reinforced annular cover traverses across and extends over each collapsible sidewall support.

Definitions

“Apex” means an elastomeric filler located radially above the bead and interposed between the plies and the ply turnup.

“Axial” and “axially” means the lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17° to 270 with respect to the equatorial plane of the tire.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing” means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire.

“Radial Ply Tire” means a belted or circumferentially-restricted pneumatic tire in which the ply cords which extend from bead to bead are laid at cord angles between 65° and 90° with respect to the equatorial plane of the tire.

“Shoulder” means the upper portion of sidewall just below the tread edge.

“Sidewall” means that portion of a tire between the tread and the bead.

“Subassembly” means an unvulcanized assembly of laminated tire components to which a cord reinforced ply or plies and other components can be added to form a tire carcass.

“Tread” means a rubber component which, when bonded to a tire carcass, includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1 is a plan view of the radially expansible drum assembly according to the present invention shown in combination with a robotic mechanism for applying ply cords;

FIG. 2 is a perspective view of the radially expansible drum assembly illustrating the drum core assembly shown in a closed position with the expandable cover removed for clarity of the internal mechanisms;

FIG. 3 is a second perspective view of the drum core assembly partially expanded illustrating the initial movement of the internal mechanism;

FIG. 4 is a third perspective view of the drum core assembly, it being understood that the inboard sidewall support assembly is identical to the outboard sidewall support assembly with the exception of being turned or facing in the opposite direction. In this view the collapsible annular sidewall supports are shown fully extended open;

FIG. 5 is a perspective view of the fully extended drum core assembly illustrating the expandable reinforced annular cover in the fully extended position;

FIG. 6 is a perspective view of the radially expansible drum core according to the present invention having the expandable reinforced annular cover stretched and in the fully collapsed position.

### DETAILED DESCRIPTION OF THE INVENTION

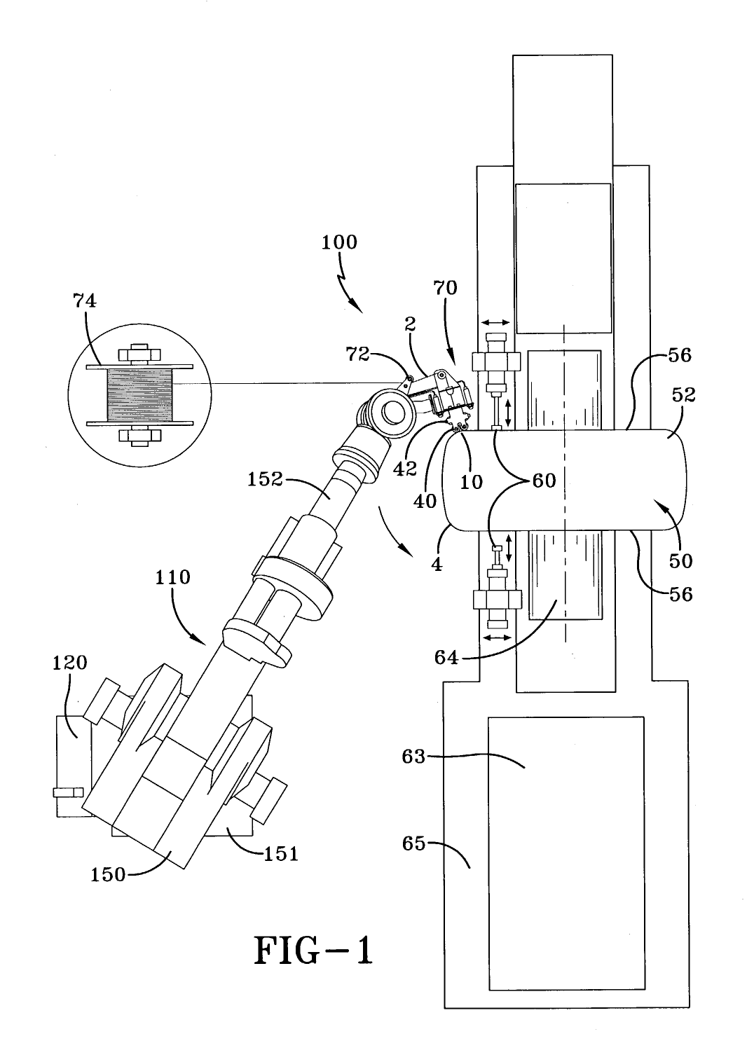

With reference to FIG. 1, a plan view of the tire building apparatus 100 of the present invention is illustrated. As shown, the apparatus 100 has a guide means which has, in addition to the ply mechanism 70, a robotic computer controlled system 110 for placing the cord 2 into the toroidially expanded surface of a building drum 50. A means for applying an elastomeric layer 4 onto the expanded cover 52 is provided which can include a server mechanism to feed strips of the layer 4 to the expanded cover 52.

The robotic computer controlled system 110 has a computer 120 and preprogrammed software which dictates the ply path 10 to be used for a particular tire size. Each movement of the system 110 can be articulated with very precise movements.

The robot 150 which is mounted on a pedestal 151 has a robotic arm 152 which can be moved in preferably six axes. The manipulating arm 152 has the ply mechanism 70 attached as shown.

Loop end forming mechanisms 60 are positioned on each side 56 of the toroidially expanded cover 52. The robotic arm 152 feeds the ply cord 2 in predetermined paths 10 and the loop end forming mechanism 60 holds the cord 2 in place as a looped end is formed. Each time an end is formed the toroidially expanded cover 52 is rotated to index to the next pitch P and the adjacent ply path 10 around the toroidially expanded cover 52.

The movement of the ply mechanism 70 permits convex curvatures to be coupled to concave curvatures near the bead areas thus mimicking the as-molded shape of the tire. A means 63 for rotating the mandrel 52 about its axle 64 are all mounted to a rigid frame 65 as shown.

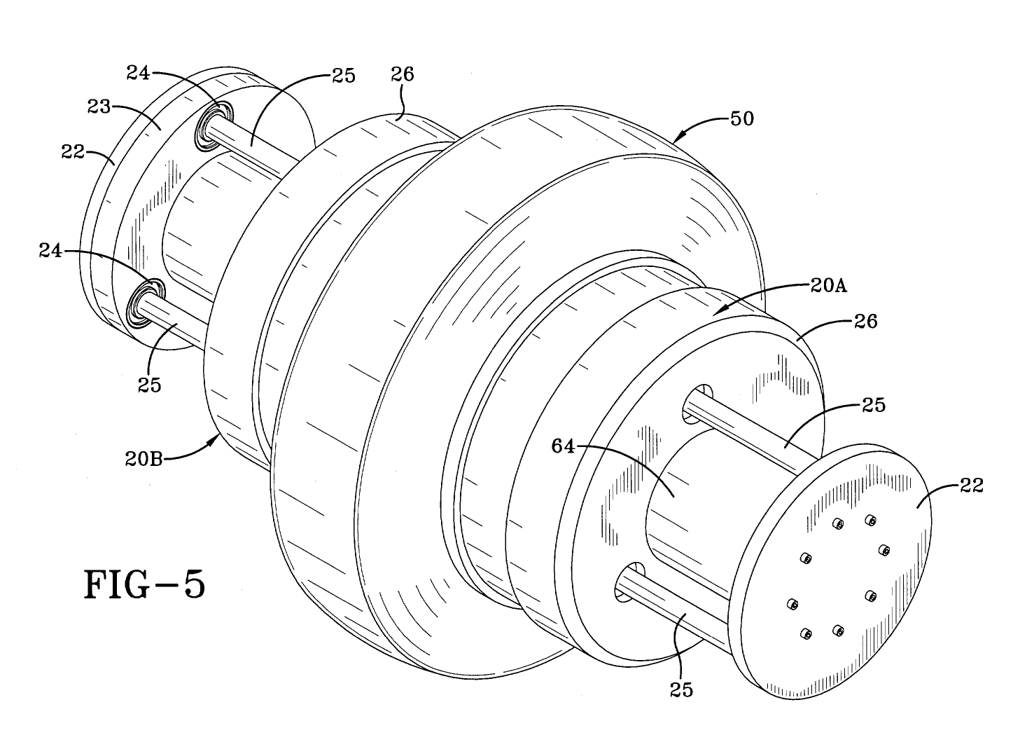

With reference to FIG. 5, a perspective view of the toroidially expandable reinforced cover 52 of the present invention is shown. As illustrated, the radially inner portions 54 on each side 56 of the toroidially expandable cover 52 have a concave curvature that extends radially outward toward the crown area 55 of the toroidal mandrel 52. As the concave cross section extends radially outward toward the upper sidewall portion 57, the curvature transitions to a convex curvature in what is otherwise known as the crown area 55 of the toroidially expandable cover 52. This cross section very closely duplicates the as-molded cross section of a tire.

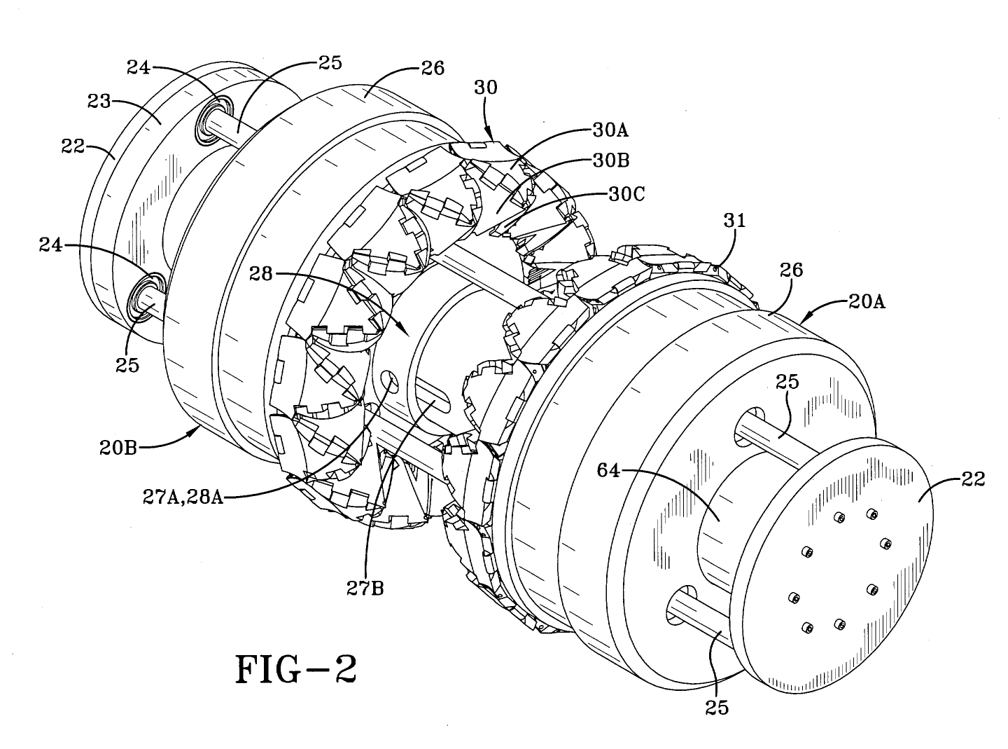

The entire drum core assembly 50 is shown in detail in FIGS. 2 through 6. In each of these figures the sequence of operation is shown from the perspective view of the drum core assembly 50.

With particular reference to FIG. 2 the drum core assembly 50 has a pair of end plates 22. These end plates provide attachment points for the entire drum core assembly to the tire building machine. The end plates 22 have four shafts connected to each plate. These shafts 25 extend throughout the drum core assembly and, as illustrated, various components are slidably attached to these shafts 25. For example, a disk 23 is shown at one end of the drum assembly. That disk has bearings 24 attached to each shaft. The disk is slidably movable along the shaft.

The drum core assembly 50 includes a pair of annular axially movable end supports 26. Attached to the end supports 26 is a pair of collapsible annular sidewall supports 30. A ring 28 is illustrated that is mounted over the axle 64. The ring has an opening 27a that provides for a cam follower 28a to ride in a slot 27b on the axle 64. This movement of the ring 28 provides axial movement inward and outward. The movement of the ring 28 is connected to the axially movable support ends 26 on each side of the drum assembly as illustrated. In FIG. 2 the drum assembly is shown without the reinforced annular cover 52 for better understanding of how the underlying mechanisms actually operate. As shown in FIG. 2, the collapsible annular side supports 30 are shown in the fully retracted or inward position. In this position the end supports 26 are axially spaced at their furthest distance apart.

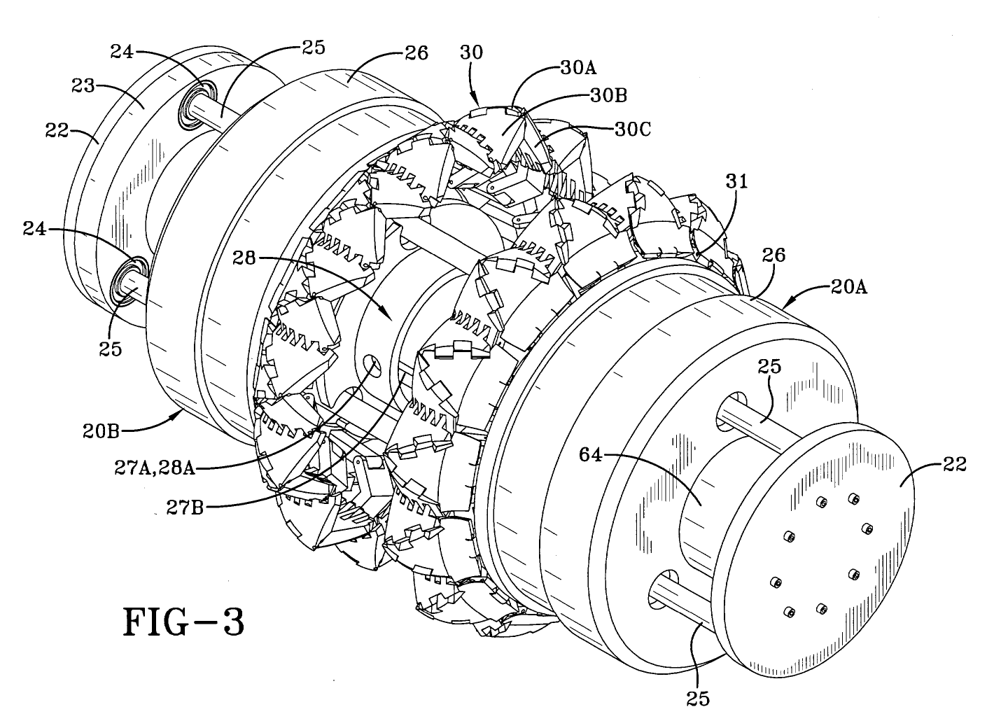

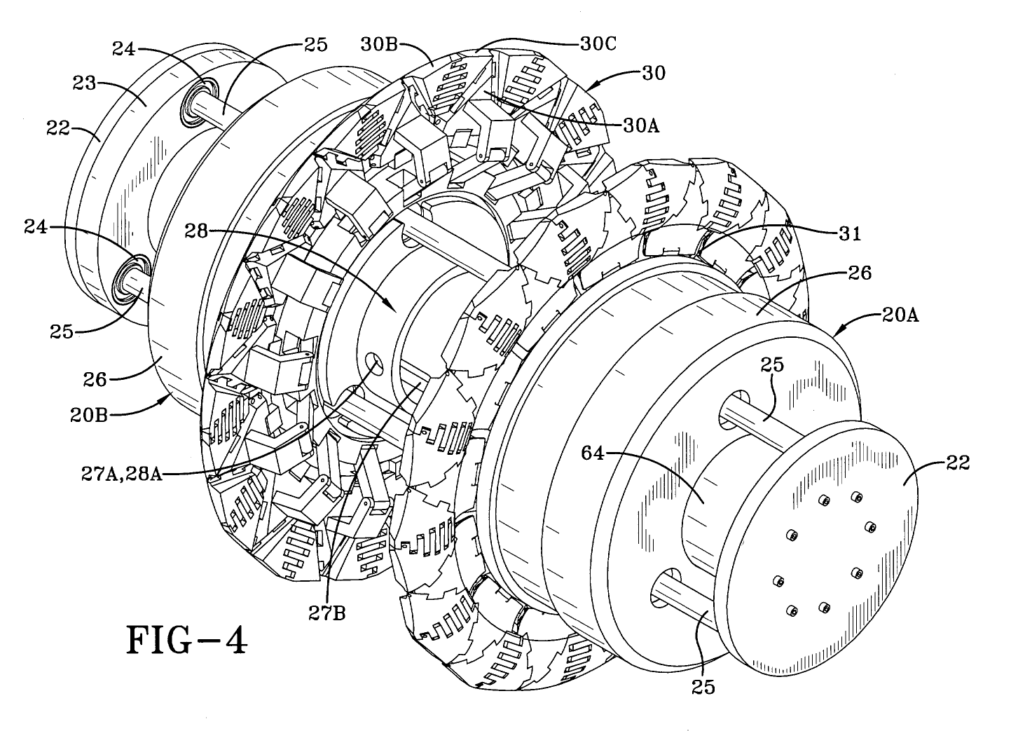

With reference to FIGS. 3 and 4 the operation of the mechanism is now described. As the ends 26 are moved axially closer together the annular sidewall supports 30 start to move radially outwardly as the axial movement of the end supports 26 are brought closer together. As illustrated, the sidewall supports 20 include several hinged components 30a, 30b, 30c that are attached by pins 31. Each of these hinged components 30a, 30b, and 30c is capable of pivotally moving relative to the adjacent hinged component, As illustrated each of the hinged components 30a, 30b and 30c has a somewhat triangular shape and, in fact, have an arcuate curvature that will simulate the sidewall of the tire to be formed when in a fully opened or expanded radial position.

As illustrated in FIG. 3, the sidewall support mechanisms 30 start to raise from the fully collapsed position of FIG. 2 to the fully extended position of FIG. 4. As shown in FIG. 4 when the movement of the sidewall support mechanism 30 is completed the bead spacing is set for the appropriate tire being manufactured and the collapsible annular sidewall supports 30 are shown forming a complete annular ring as illustrated in FIG. 4, this annular ring provides a rigid support across the entire sides of the building drum. All this movement occurs in concert with the movement of the end supports 26 axially inwardly.

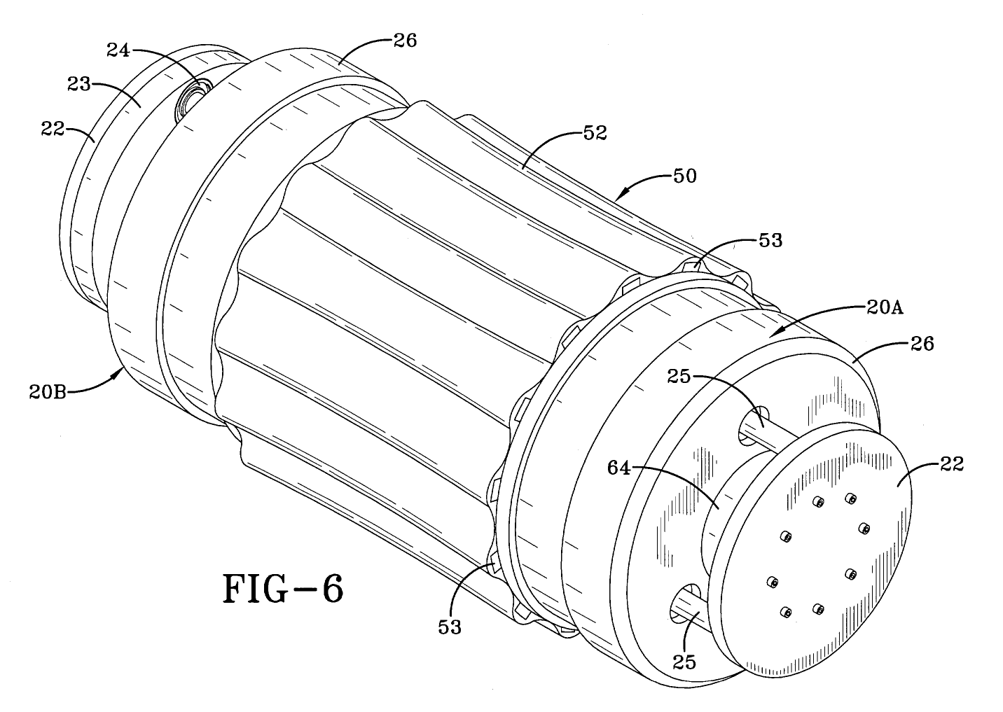

With reference to FIG. 5 the flexible reinforced annular cover 52 is illustrated over or covering the fully extended collapsible annular sidewall supports 30 illustrated in FIG. 4. In other words, the building drum assembly 50 as illustrated in FIG. 5 shows the position of the flexible member or cover 50 when the collapsible annular sidewall supports 30 are fully extended. This is the tire building mode. To remove the tire carcass from the drum assembly 50, one simply extends axially outward the two end supports 26. As the ends 26 move, the tire building drum 50 and the cover 52 are drawn radially inwardly as the end supports 26 move axially outwardly. In this position the collapsible sidewall supports 30 that are covered by the cover 52 are in the position shown in FIG. 3 and this is represented by the illustration shown in FIG. 6 wherein the cover 52 is concealing the collapsed annular sidewall supports 30.

The above tire building core permits the building of the tire carcass onto a toroidially expanded building drum assembly 50 by applying the carcass components onto a cover 52 of a toroidially expanded building drum core at a first diameter D₁ while rigidly supporting the sides 56 of the cover 52 with a pair of internal collapsible sidewall support mechanisms 30 to form the toroidially shaped uncured carcass. The reinforced expanded cover 52 can then be further expanded by an amount less than 5% greater than the diameter D₁ by applying an internal pressure to the expanded cover 52. This expanded cover 52 can then slightly grow in diameter at an amount less than 5% greater than the diameter D₁. After this additional growth in the cover 52 is achieved, one can simply add a belt reinforcing structure or tread belt reinforcing structure onto the expanded cover to form an uncured tire assembly which may further include the step of taking the entire uncured tire while mounted onto the drum assembly and placing that entire assembly into a tire curing mold and removing the cured tire assembly from the mold collapsing the toroidially expanded building drum core and removing the cured tire from the collapsed core. Alternatively, the method may involve the steps of collapsing the radially expanded building drum core and removing the formed uncured carcass from the collapsing building drum core without utilizing the building drum core in the tire curing mold. It is understood that the step of inflating the reinforced uncured tire assembly slightly during the building may be eliminated or may be conducted only when the entire assembly is placed in the curing mold. At that point additional pressure can be applied such that the cover 52 pushes against the uncured tire and forces it into the mold, all of this being achieved at a very minimal amount of increase in diameter. It is believed important that the uncured tire be assembled in a fashion that very closely approximate the curing dimensions. Having accomplished this, movements of the cords 2 and underlying reinforcing structures commonly found in tires can be greatly minimized. Once a tire is cured its cords are embedded into the cured rubber in such a fashion that they will not move. Current manufacturing of tires requires large amounts of expansion of the uncured rubber along with embedded reinforcing cords during various stages of the tire building. This is particularly true when tires are assembled on the flat cylindrical building drum and inflated into a toroidal shape. When this occurs, the reinforcing cords must stretch and expand as the movement radially outwardly is increased. The stretching movement of the cords changes the pitch and creates opportunities for non-uniformities to occur in the tire. By building the tire using the building drum 50 of the present invention the amount of stretch or change during tire building is greatly minimized. This ensures that the cords when placed onto the building drum remain in that position after cure or as close as possible to the as built condition once the tire is cured. It is an objective of the present invention to ensure that the cords are basically in almost the same position as they were applied before curing when the tire is finally cured. It is believed that the present invention provides a very efficient way to mold the tire in the as-built position without any distortion of the cords. As noted the overall tire building system is fully described in a related patent application Serial No. 10/365,374, filed Feb. 11, 2003, entitled “An Improved Method and Apparatus For Manufacturing Carcass Plies For a Tire”. That patent is incorporated herein by reference in its entirety. That patent discloses how cords can be laid at various angles including radial to build radial type tires, on a bias to build bias-type tires or, alternatively, to build on any cord angle that is not included in the general species of radial or bias including, but not limited to, geodesic type ply cord angles. The present building drum 50 provides a maximum amount of efficiency to build the tire in a superior fashion to those of the known prior art. It is important that the sidewalls have the necessary curvatures to duplicate the as-finished tire. It is believed that this provides a far superior way of building a tire. It is further believed important that the sidewalls should be rigidly supported during the tire building process. This greatly facilitates locating the components in a very precise manner. Across the crown area of the tire it is very important that the expandable cover 52 also be rigidly supported. It is therefore recommended that the expandable cover 52 be made out of a material that can provide limited expansion under pressure but also provide a very rigid support across the top member. As a result it is recommended that the cover be reinforced with support members 53 of either plates, rods or other mechanisms to provide a somewhat rigid crown area so that the ply components can be added without movement in this area. With reference to FIG. 6, one can see that the sidewall support mechanisms 30 internal of the cover 50 provide sufficient sidewall support while the support members 53 provide radial support when the cover 52 is fully expanded. The support members 53 are shown extending transversely across the cover 52 and embedded therein. Alternatively, the support members 53 can be positioned on a bias. However, this creates more problems when one tries to collapse the sidewall supports 30 in a fully retracted position for removal of the built and finished tire.

What is claimed is:

1. A method of building a tire carcass onto a toroidially expanded building drum core, the method comprising the steps of:
applying the carcass components onto a cover of the toroidially expanded building drum core at a first diameter D₁ while rigidly supporting the sides of the cover with a pair of internal side support mechanisms to form a toroidially shaped uncured carcass.

2. The method of claim 1 further comprising the steps of:
expanding the cover radially by an amount less than 5% greater than the diameter D₁ and applying a belt reinforcing structure or a tread and belt reinforcing structure onto the expanded cover to form an uncured tire assembly.

3. The method of claim 2 further comprising the step of:
curing the uncured tire assembly in a tire curing mold;
removing the cured tire assembly from the mold;
collapsing the toroidially expanded building drum core; and
removing the tire from the collapsed core.

4. The method of claim 1 further comprises the steps of:
collapsing the radially expanded building drum core; and
removing the formed uncured carcass from the collapsed building core.

5. The method of claim 4 wherein the step of collapsing the radially expanded core includes the steps of:
axially increasing the spacing between the rigidly supported sides and radially lowering the internal side support mechanisms.

6. The method of claim 5 wherein the steps of lowering the internal side support mechanisms includes the steps of pivotally moving hinged elements of the internal side support mechanisms.

7. A tire building drum rotatable about an axis of rotation, comprising a pair of annular axially movable end supports;
a pair of collapsible sidewall supports, one collapsible sidewall support being pivotally attached to each axially movable end support, each sidewall having a plurality of pivotally movable hinged elements, the plurality of hinged elements when extended radially from an annular sidewall support;
an expandable reinforced annular cover, the cover traversing across and extending over each collapsible sidewall support;
a means for rotating the building drum; and
a means for axially moving the annular axially movable end supports.
